(19) United States
(12) Patent Application Publication
(10) Pub. No.: US 2011/0112840 A1
(43) Pub. Date: May 12, 2011

(54) SYNTHETIC SOUND GENERATION METHOD AND APPARATUS

(75) Inventor: Shinichi Sakamoto, Saitama (JP)

(73) Assignee: OTODESIGNERS CO., LTD., Wako-shi, Saitama (JP)

(21) Appl. No.: 13/003,632

(22) PCT Filed: Feb. 13, 2009
(86) PCT No.: PCT/JP2009/000565

§ 371 Date: Jan. 12, 2011

(30) Foreign Application Priority Data
Jul. 11, 2008 (JP) 2008-181083

(51) Int. Cl. G10L 11/00

(52) U.S. Cl. 704/266; 704/E11.001

(57) ABSTRACT

A synthetic sound generation method for generating a synthetic sound for making a listener recall an image of an actual sound signal which is a sound signal other than a speech signal and of which the listener knows what sound the actual sound signal is, by hearing the speech signal, comprising the steps of: extracting a signal of a predetermined frequency band of an inputted speech signal; extracting an amplitude envelope curve component of the extracted signal; extracting a signal of a predetermined frequency band of the actual sound signal which is a sound signal other than the speech signal and of which the listener knows what sound the actual sound signal is; and multiplying the amplitude envelope curve component of the inputted speech signal and the extracted predetermined frequency band signal of the actual sound signal.

### TECHNICAL FIELD

The present invention relates to a synthetic sound which is distinctive and has an impact on end users, comprising information on the amplitude envelope curve of a speech signal and a frequency component of a sound signal other than the speech signal. Such synthetic sound can be used for a sound effect used in an advertisement of television, radio, etc., a sound logo to publicize a corporate image and sound contents used in movies, animations, games, toys or ring tones of mobile phones.

### BACKGROUND ART

In commercials on such as TV and radio, speech such as a name of a product, or a message for promoting the product comes on the air together with a video for advertising the product. As well known, such speech for commercial is often broadcasted with BGM (background music) for improving the image of a product and sound effects that fit its image (such as the sound of a river or stream and the chirping of birds) overlapped thereon.

In recent years, in addition to visual corporation logos used for establishing an image of a corporation in end users, sound logos are generally used, which are advertising tools that use a specific sound for advertising a specific corporation so that users can recall the corporation or its product simply upon hearing the sound.

In games, animations, movies, toys and the like, various kinds of sound effects have been used conventionally. Game technologies have also been disclosed recently that enable the user to enjoy the game by the sound itself, instead of merely using the sound as a sound effect.

Patent document 1 discloses a hearing aid, a training apparatus, a game apparatus and a sound output apparatus that use a noise-vocoded speech sound signal which is obtained by forming the components of a sound source from noises by: dividing a speech signal into a plurality of band signals and extracting the envelope curves therefrom and further extracting each of the envelope curves; inputting a noise source signal to a band filtering unit having a plurality of band filters to extract respective noise source signals; multiplying the output of each band filtering unit by each noise source signal; and summing the multiplication products.

A noise-vocoded speech sound is a speech sound signal which is made by replacing all the frequency components used by a human in order to recognize the content of a speech sound, the type of an environmental sound and the like with noises. Therefore, only amplitude envelope curve information that is otherwise rarely used for recognition of the speech sound content are left in the noise-vocoded speech sound.

When the frequency components usually used are eliminated, a human initially cannot recognize the content of the speech sound as a matter of course, but when he/she is presented with the content of the speech once, it soon becomes possible for him/her to recognize the content of the speech.

The reason for this is that the human brain has an ability to change a network in the brain so that amplitude envelope curve information that is not usually used can be used, and thus, from this theory, it has been proposed as a method that can be used for such as hearing aid, training apparatus, and game contents for brain training.

On the other hand, in movies and animations, stories are often employed in which natural things such as the wind, trees, falls, and rivers are anthropomorphized so that they can speak. Such speech of anthropomorphized things is subjected to a process, such as frequency conversion or speech speed conversion, in accordance with a certain rule for realizing the nature of the wind or the tree.

For users of mobile phones with ring tone function, services are widely provided in which music can be downloaded therefrom to be used for a ring tone. In other recent popular services, a high frequency sound, referred to as “a mosquito sound”, are used as ring tone. The mosquito sound cannot be heard by aged persons whose capacity of hearing tends to reduce in high frequency regions, but can be heard only by young persons having healthy hearing capability. Thus, as well known, needs for contents of interesting sounds and sounds which are audible to only the users are increasing.

Patent document 2 describes a method of notifying a mobile phone of an incoming call for enabling the user to receive a message by an incoming call notification sound while mitigating uncomfortable feelings felt by other persons, comprising: converting voice/text data, such as data from a microphone of a mobile phone, text entry from operation keys, text data stored in a memory, data of photographing a QR code by a camera, data from a non-contact-type IC card and received data from an IrDA receiver, into a noise-vocoded speech sound signal using a noise-vocoded speech sound signal conversion function of the mobile phone itself or a noise-vocoded speech sound signal generation server connected via a network; and using this converted data as an incoming call notification sound of the mobile phone.
Patent document 1: Japanese Patent No. 3973530
Patent document 2: Japanese Patent No. 3833243

### DISCLOSURE OF THE INVENTION

### Problems to be Solved by the Invention

In the conventional method of overlapping BGM or a sound effect with a product name, a corporation name or a product advertising speech, two different sounds: an advertising speech and a BGM are simultaneously presented. Such a method is so common and ordinary that it is difficult to have a strong impact on users with this technology.

There is another method which promotes awareness of users by generating distinctive sound that has strong impact on the user, such as a loud sound, abrupt sound or intentional uncomfortable sound. Such an approach, however, may ruin the corporate reputation, and, if the sound is recognized as a noise, this may lead to a social problem.

In the case of a sound logo, a variety of specific signal sounds presented in commercial of game machine makers, CPU makers for a personal computer, mobile telephone carriers and the like, have successfully improved corporate images. In this case, however, all of such cases require a lot of advertising expense because such sound has to be played continuously in every media until a time when many users become able to recall the name of a corporation from a specific signal sound.

Further, because, in most cases, commercials use a one-shot and simple signal sound in order not to cause discomfort while inviting user's attention, there has been a problem that it is difficult to convey a corporate name and a product name directly by only that sound.

Although the noise-vocoded speech sound described in patent document 1 has distinctiveness, it is a sound of “husky and noisy” feeling because it is generated from a noise. Such sound is not suitable for corporate advertisement to improve the corporate image.

Moreover, while the noise-vocoded speech sound has an effect on the training of the human brain and also causes a surprise effect (or impact) that its meaning cannot be understood in the beginning of listening but can be understood once he/she knows the identification, it has disadvantages: that it does not have distinctiveness and thus end users always soon get tired of it because the speech sound becomes a sound having the same “husky and noisy” hearing impression always as a result of using a noise as a base; and it does not have an effect on conveying the images of a company or a product.

The traditional anthropomorphized voices that have been used in movies and animations also have problems: that they are merely produced according to images of the production side and thus there are cases where such images cannot be conveyed to some listeners; and that enormous efforts are needed to produce sound effects and anthropomorphized sounds for the work.

Also, regarding ring tones of a mobile phone, although various sound contents have been proposed such as a mosquito sound and an incoming call notification method described in patent document 2, it has been very difficult to continue producing contents which have distinctiveness and impact on users and which does not bore the users.

### Means for Solving the Problems

As means for solving the problems mentioned above, a synthetic sound according to the present invention is made by synthesizing an amplitude envelope curve component and a frequency component in order to make a listener recall an image of a sound signal other than a speech signal by listening to the speech signal, wherein the amplitude envelope curve component is an amplitude envelope curve component of the speech signal, and wherein the frequency component is a frequency component of the sound signal other than the speech signal except a noise.

Also, a synthetic sound according to the present invention is made by synthesizing an amplitude envelope curve component and a frequency component in order to make a listener recall an image of a sound signal other than a speech signal by listening to the speech signal, wherein the amplitude envelope curve component is an amplitude envelope curve component of a signal of each frequency band when the speech signal is divided into a plurality of frequency bands, and wherein the frequency component is a frequency component of each frequency band when the sound signal other than the speech signal except a noise is divided into the plurality of frequency bands.

### Advantages of the Invention

In a synthetic sound and a sound synthesis processing apparatus according to the present invention, because the synthetic sound is produced not by overlapping BGM or sound effects with speech but by using a sound other than speech as a sound source, it is possible for users to recall its image only by hearing the synthetic sound.

The conventional overlapped sound in which a plurality of sounds (speech and sound effects or an image sound) are presented simultaneously does not have distinctiveness as a single unique sound. On the other hand, a synthetic sound according to the present invention has distinctiveness as “a single unique sound” having both the characteristics of speech and the characteristics of a sound other than the speech.

Accordingly, when such a unique sound is used in corporate advertisements or sound logos, it is possible to give distinctive, new impact on and promote the awareness of users without making an accidental sound or making an unpleasant sound intentionally.

Further, such a unique sound does not have a “husky and noisy” hearing impression always for the noise-vocoded speech sound, and, by using various sounds as the sound other than the speech concerned, it is possible to continuously provide new impactful sound contents which have distinctiveness and do not bore users.

If various kinds of sounds are prepared to be used as the signals other than the speech concerned is prepared, it becomes possible to continuously provide sound contents that are distinctive, fit the corporate image and do not bore users at any time, as sound effects in movies and the like, anthropomorphized sounds, ring tones of a mobile phone or game sounds.

These effects are achieved by the synthetic sound according to the present invention including the amplitude envelope curve component of speech and the frequency component of a sound signal other than the speech signal, and when it is configured such that the amplitude envelope curve component is an amplitude envelope curve component of a signal of each frequency band when the speech signal is divided into a plurality of frequency bands, and the frequency component is a frequency component of each frequency band when the sound signal other than the speech signal is divided into the plurality of frequency bands, the semantic meaning of the speech signal can be made more easily understood.

### BRIEF DESCRIPTION OF THE DRAWINGS

FIG. 1 is a diagram showing a first embodiment of the present invention (an example of a waveform and a sound spectrogram of a synthetic sound);

FIG. 2 is a diagram showing a second embodiment of the present invention (an example of a waveform of a synthetic sound);

FIG. 3 is a diagram showing the second embodiment of the present invention (an example of a sound spectrogram of the synthetic sound);

FIG. 4 is a first block diagram for generating a synthetic sound according to the present invention;

FIG. 5 is a second block diagram for generating a synthetic sound according to the present invention; and

FIG. 6 is a detailed drawing in the second block diagram.

### DESCRIPTION OF SYMBOLS

1 . . . First band filter unit, 2 . . . Envelope curve extracting unit, 3 . . . Second band filter unit, 4 . . . Band filter, 5 . . . Envelope curve extractor, 6 . . . Band filter, 7 . . . Multiplier, 8 . . . Adder.

### BEST MODE FOR CARRYING OUT THE INVENTION

Hereinafter, best modes for carrying out the present invention will be described in detail with reference to the drawings. Meanwhile, in the following description, components having like functions are denoted by like reference symbols, and the description thereof will not be repeated.

### Example 1

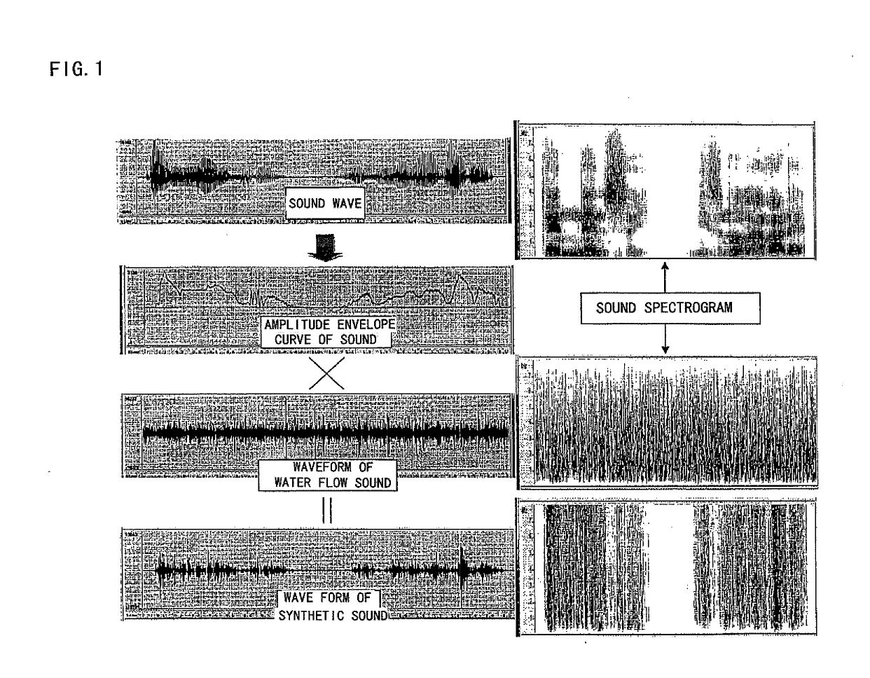

FIG. 1 shows an example of a temporal waveform of a synthetic sound of the present invention as a first embodiment of the present invention. The upper left portion of the figure shows an input speech signal, and, in the right side of this, a sound spectrogram of the input speech signal is shown (in the sound spectrogram, the horizontal axis indicates time and the vertical axis indicates a frequency, and a strength of energy is represented by a shading of color).

Under the input speech signal waveform, an amplitude envelope curve of the input speech signal is shown, and, below the envelope curve, there are indicated a waveform of a sound of water flowing as a sound other than the input speech signal and its sound spectrogram.

At the bottom, there is indicated a synthetic sound of the present invention synthesized by multiplying the amplitude envelope curve component and the water flow sound. From the waveforms and the sound spectrograms, it is found that, in the synthetic sound of the present invention, the amplitude envelope curve component includes the amplitude envelope curve component of the speech signal concerned, and the frequency components include the frequency components of the water flow sound (a sound signal other than the speech signal concerned).

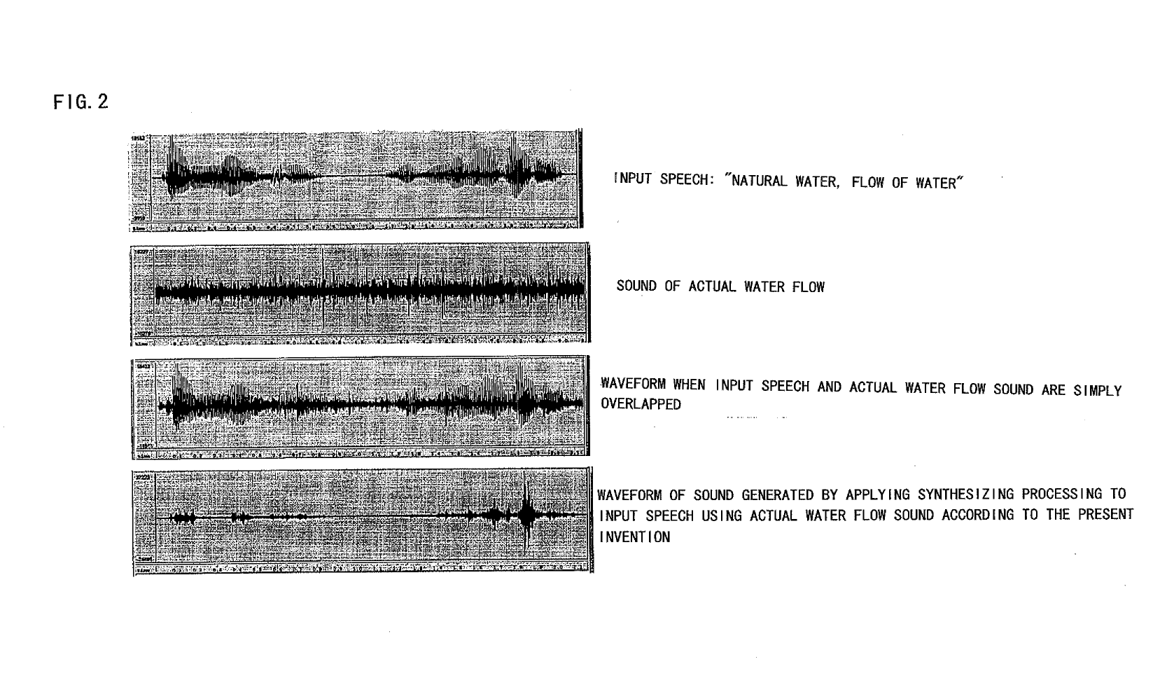

In FIG. 2, as a second embodiment of the present invention, there is shown an example in which speech and a sound other than the speech are divided into four frequency bands: (−600 Hz), (600 Hz-500 Hz), (1500 Hz-2500 Hz) and (2500 Hz-4000 Hz) and then synthesized. In this order from the top, there are shown: an input speech signal (the content of the speech: “Natural water, a flow of water” spoken in Japanese); a sound of an actual water flow; the waveform when the input speech signal and the sound of an actual water flow is overlapped simply; and a waveform of a sound which is synthesized using “Natural water, a flow of water” as an input speech signal of the present invention and the sound of the actual water flow as a signal other than the speech signal of the present invention.

Here, it is supposed that it is an advertisement for a mineral water, and thus it is desired that a fresh sound of water flowing is heard by users along with an announce sound for the advertisement. Note that almost all of the conventional sound contents of advertisements, movies, game machines, mobile phones and the like have been produced by simple overlapping of both sounds.

However, as is clear from the waveform in the figure, a sound made by a simple overlapping has weak distinctiveness as one unique sound because two sounds, the speech and the water flow, are being intermingled, and, in addition to this, it is hard to hear due to mix of the two sounds. It becomes noisy when the volume of the speech is turned up in order to make the speech were easily heard, and, inversely, when the volume of the water flow is increased, it becomes noisy and the announcer's voice which is most important becomes hard to hear.

Further, it is a well known fact that such advertisement sounds and sound contents are so common these days that they have low distinctiveness, and thus they do not have an impact on users any more.

On the other hand, the synthetic sound according to the present invention shown at the bottom has a high distinctiveness as one unique sound, has an impact, and a user can recognize the content of an announcer's voice and the sound of the water flow simultaneously without turning up the sound volume because the sound is synthesized using the sound of flowing water.

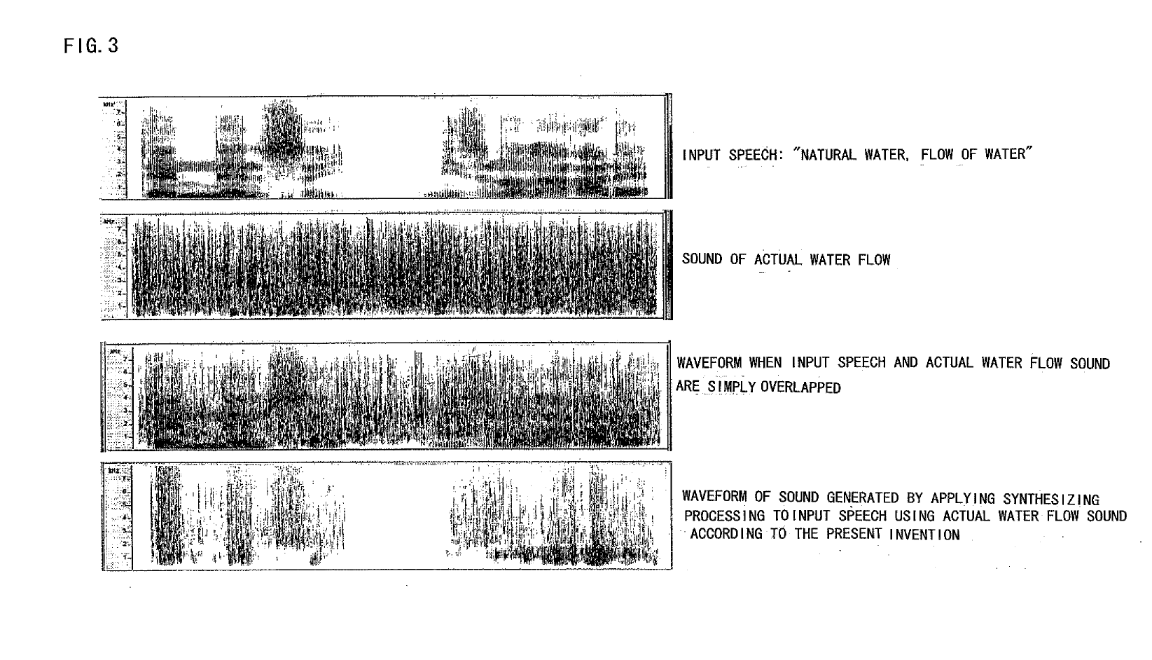

FIG. 3 shows sound spectrograms of each sound shown in FIG. 2. In the sound which is made by simply overlapping the sound of water flow, the sound of water flow is being overlapped with the speech over all the frequency bands.

On the other hand, in the sound according to the present invention synthesized using the sound of flowing water, although the original feature of the speech frequency components is not maintained in terms of preciseness, and the frequency components in each band are replaced by the frequency components of the sound of the water flow, the amplitude envelope curve of each frequency band indicated by a shading of color remains the same as that of the original speech.

Therefore, although it may be difficult to understand the content of the speech at first just like a noise-vocoded speech sound described in patent document 1, it becomes possible to be understood once the answer (the content of the speech) is known because the amplitude envelope curve information is maintained, and also it becomes possible to convey the image of the sound of the water flow.

In addition, it should be noted that the impact on users is great because there is no such voice made from sound of flowing water as shown in the present example in the natural world.

A noise-vocoded speech sound is a sound which is made by using only the amplitude envelope curve information of the speech after replacing the frequency information of the speech with a noise so that the original frequency information of the speech are removed. The purpose of this is “brain training” for stimulating brain activation, and thus it has been premised on using an entirely featureless noise (a white noise) having uniform frequency components and a straight-line amplitude envelope curve.

Accordingly, it has been considered that when instead of white noise a meaningful actual sound (a sound that listeners know what sound it is) such as flowing water sound is used as the sound signal other than the speech concerned, the resultant sound cannot be a sound having an understandable semantic meaning, since such a actual sound has its own amplitude envelope information on the sound characteristics.

However this time, as a result of a trial and error approach under various conditions, a new finding has been obtained that even a synthetic sound as shown in the present example can sufficiently convey semantic meanings and also have high distinctiveness as one unique sound and have an impact on listeners. Thus, the present invention has been achieved.

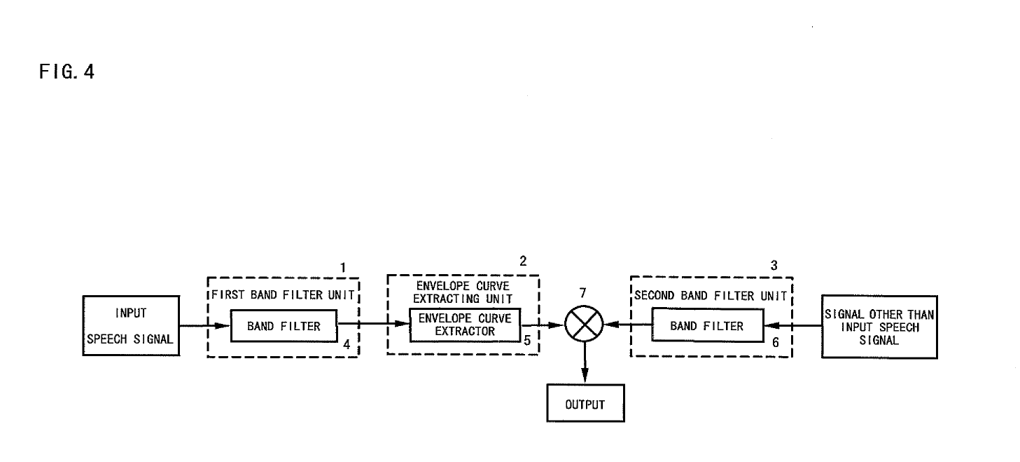

FIG. 4 is a first block diagram for generating a synthetic sound of the present invention, including: a first band filter unit 1 having a band filter 4; an envelope curve extracting unit 2 having an envelope curve extractor 5; a second band filter unit 3 having a band filter 6; and a multiplier 7.

An input speech signal is input to the first band filter unit 1 and is limited to a signal of a predetermined frequency band by the band filter 4, and then amplitude envelope curve information is extracted by the envelope curve extractor 5 of the envelope curve extracting unit 2. On the other hand, a signal other than the input speech signal is input to the second band filter unit 3, and is limited to a signal of a predetermined frequency band by the band filter 6.

The amplitude envelope curve of the band-filtered input speech signal that is output of the envelope curve extractor 5 and the band-filtered signal other than the input speech signal that is the output of the band filter 6 are multiplied by the multiplier 7 to be output.

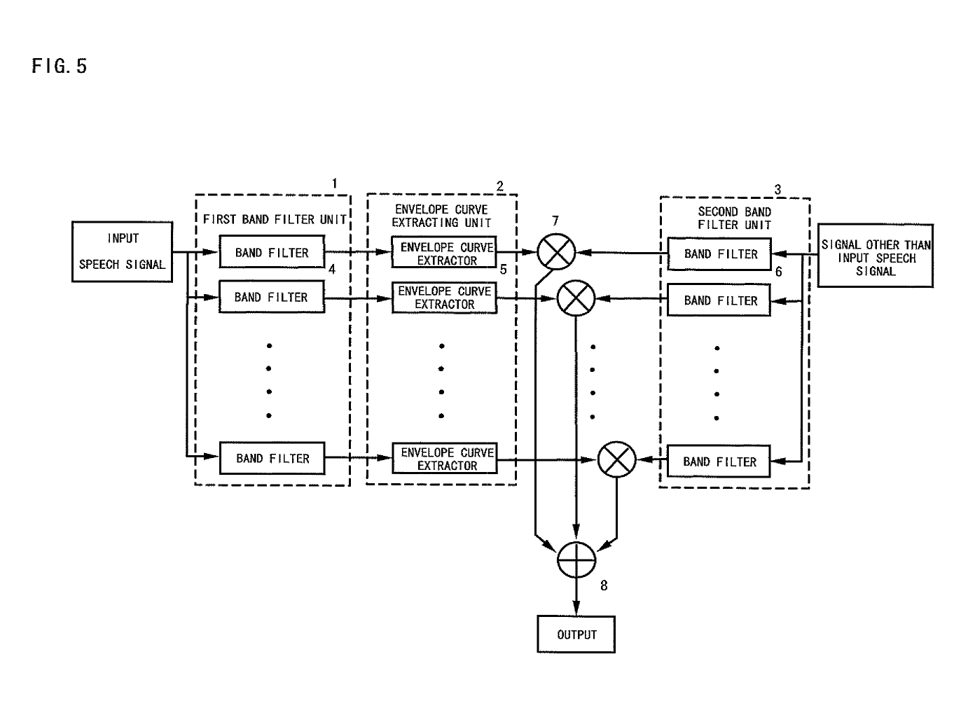

FIG. 5 is the second block diagram for generating a synthetic sound of the present invention, including: a first band filter unit 1 having a plurality of band filters 4; an envelope curve extracting unit 2 having a plurality of envelope curve extractors 5; a second band filter unit 3 having a plurality of band filters 6; a plurality of multipliers 7; and an adder 8.

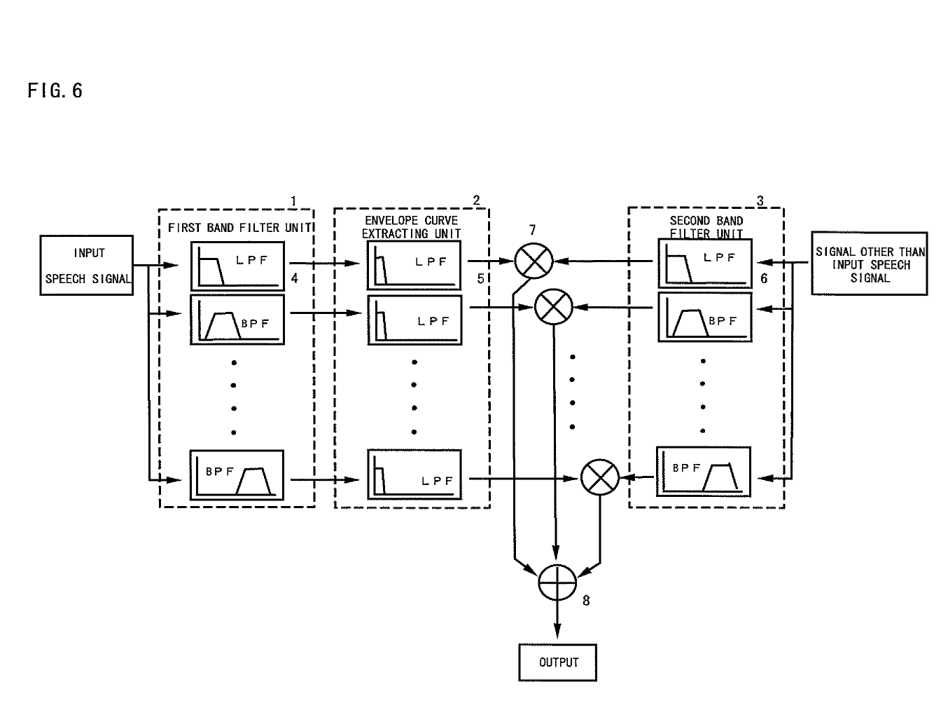

The second block diagram will be described with reference to FIG. 6 in detail. In FIG. 6, the first band filter 4 of the first band filter unit 1 is configured by an LPF (low-pass filter), and the second and subsequent band filters 4 are configured by BPFs (band-pass filters) whose pass bands are different from each other.

Here, it is supposed that, when the first band filter unit 1 includes four band filters 4, for example, the cutoff frequency of the first one, which is a LPF, and the lower limit frequency and the upper limit frequency of the second and subsequent BPFs are set as values around (600 Hz), (600 Hz, 1500 Hz), (1500 Hz, 2500 Hz), (2500 Hz, 4000 Hz), respectively, in consideration of general frequency values of a characteristic quantity which is important for phonetic perception such as a formant frequency.

Outputs of these band filters 4 are input to the respective envelope curve extractors 5 which are configured by a LPF in order to extract amplitude envelope curve information of an input speech. Here, the purpose of the envelope curve extractor 5 is to extract the envelope curve of the amplitude of the input signal (that is, information on the strength of a sound). Therefore, the envelope curve extractor 5 is configured by an LPF or the like having a cutoff frequency of 10 Hz-20 Hz in order to eliminate unnecessary frequency information other than the amplitude envelope curve and leave only the amplitude envelope curve information.

Meanwhile, although it is not shown here, note that a half-wave rectifier may be provided in a former or latter stage of the LPF having a cutoff frequency of 10 Hz-20 Hz so that an amplitude envelope curve configured by positive components can be obtained.

On the other hand, a signal other than the input speech signal is inputted to the second band filter unit 3 composed of the band filters 6 (LPF and BPF) having a cutoff frequency, upper limit frequencies and lower limit frequencies similar to those of the band filters 4.

Each output of the envelope curve extracting units 5 and corresponding output of the band filters 6 are multiplied by the multiplier 7. At this time, frequency information of the input speech signal within a pass band, which has passed each of the band filters 4, has been replaced with frequency information of a signal other than the input speech signal within a corresponding band entirely. That means that information of the input speech signal has become only amplitude envelope curve information in each of the pass bands. Finally, outputs of the respective multipliers 7 are added by the adder 8 to be outputted.

Meanwhile, although the speech and the sound other than the speech are divided into four frequency bands of (−600 Hz), (600 Hz-500 Hz), (1500 Hz-2500 Hz) and (2500 Hz-4000 Hz) in the present example, it is possible to arbitrarily change the number of divided bands, and a cutoff frequency, a lower limit frequency and an upper limit frequency at that time according to the content of the speech, the characteristics of the sound signal other than the speech and the object of the advertisement and its content.

Also in this example, although an input speech signal (an announcer's voice of an advertisement) is input to the first band filter unit 1 and a signal other than the input speech signal (an image sound: a sound of flowing water) to the second band filter unit 3, the signal other than the input speech signal (an image sound: a sound of flowing water) may be input to the first band filter unit 1 and the input speech signal (an announcer's voice of an advertisement) to the second band filter unit 3.

In this case, because the amplitude envelope curve information of the signal other than the input speech signal is maintained and synthesis processing is carried out using the frequency information of the speech, and thus, when a sound with a characteristic amplitude envelope curve (a sudden sound, such as when a door is closed, or a crisp sound as when eating a Japanese rice cracker) is used, synthesis processing of a sound having a stronger impact can be achieved.

Further in the present example, although a sound of flowing water is used as the signal other than the input speech signal, it should be noted that such signal does not need to be a flowing water sound, and can be various sounds according to the company and product needing to be advertised.

For example, because synthesis processing can be performed using various environmental sounds (the sound of the wind, the sound of waves, the chirp of an insect or an animal etc.), the sound of a car engine, the sound when eating potato chips, the sound from a piece of ice hitting a glass, some kind of music, a piece of music or the sound of singing, it is possible to always provide new and impactful sounds one after another without boring users.

Furthermore, not only as a commercial voice or a sound used for a sound logo as shown in the present example, but also as sound contents, sound effects and anthropomorphized voices in a medium, software, products and the like such as movies, dramas, animations, games and ring tones of a mobile phone, the sound of the invention is usable in all products using a sound.

### FIG. 1

#1 SOUND WAVE
#2 AMPLITUDE ENVELOPE CURVE OF SOUND
#3 WAVEFORM OF WATER FLOW SOUND
#4 WAVE FORM OF SYNTHETIC SOUND
#5 SOUND SPECTROGRAM

### FIG. 2

#1 INPUT SPEECH: “NATURAL WATER, FLOW OF WATER”
#2 SOUND OF ACTUAL WATER FLOW
#3 WAVEFORM WHEN INPUT SPEECH AND ACTUAL WATER FLOW SOUND ARE SIMPLY OVERLAPPED
#4 WAVEFORM OF SOUND GENERATED BY APPLYING SYNTHESIZING PROCESSING TO INPUT SPEECH USING ACTUAL WATER FLOW SOUND ACCORDING TO THE PRESENT INVENTION

### FIG. 3

#1 INPUT SPEECH: “NATURAL WATER, FLOW OF WATER”
#2 SOUND OF ACTUAL WATER FLOW
#3 WAVEFORM WHEN INPUT SPEECH AND ACTUAL WATER FLOW SOUND ARE SIMPLY OVERLAPPED
#4 WAVEFORM OF SOUND GENERATED BY APPLYING SYNTHESIZING PROCESSING TO INPUT SPEECH USING ACTUAL WATER FLOW SOUND ACCORDING TO THE PRESENT INVENTION

### FIG. 4

1 FIRST BAND FILTER UNIT
2 ENVELOPE CURVE EXTRACTING UNIT
3 SECOND BAND FILTER UNIT
4 BAND FILTER
5 ENVELOPE CURVE EXTRACTOR
6 BAND FILTER
#1 INPUT SPEECH SIGNAL
#2 SIGNAL OTHER THAN INPUT SPEECH SIGNAL
#3 OUTPUT

### FIG. 5

1 FIRST BAND FILTER UNIT
2 ENVELOPE CURVE EXTRACTING UNIT
3 SECOND BAND FILTER UNIT
4 BAND FILTER
5 ENVELOPE CURVE EXTRACTOR
6 BAND FILTER
#1 INPUT SPEECH SIGNAL
#2 BAND FILTER
#3 ENVELOPE CURVE EXTRACTOR
#4 SIGNAL OTHER THAN INPUT SPEECH SIGNAL
#5 OUTPUT

### FIG. 6

1 FIRST BAND FILTER UNIT
2 ENVELOPE CURVE EXTRACTING UNIT
3 SECOND BAND FILTER UNIT
#1 INPUT SPEECH SIGNAL
#2 SIGNAL OTHER THAN INPUT SPEECH SIGNAL
#3 OUTPUT

1. A synthetic sound generation method for generating a synthetic sound for making a listener recall an image of an actual sound signal which is a sound signal other than a speech signal and of which the listener knows what sound the actual sound signal is, by hearing the speech signal, comprising the steps of: extracting a signal of a predetermined frequency band of an inputted speech signal; extracting an amplitude envelope curve component of the extracted signal; extracting a signal of a predetermined frequency band of the actual sound signal which is a sound signal other than the speech signal and of which the listener knows what sound the actual sound signal is; and multiplying the amplitude envelope curve component of the inputted speech signal and the extracted predetermined frequency band signal of the actual sound signal.

2. A synthetic sound generation method for generating a synthetic sound for making a listener recall an image of an actual sound signal which is a sound signal other than a speech signal and of which the listener knows what sound the actual sound signal is, by hearing the speech signal, comprising the steps of: dividing an inputted speech signal into a plurality of frequency bands; extracting an amplitude envelope curve component of each of the divided frequency band signals; dividing the actual sound signal which is a sound signal other than the speech signal and of which the listener knows what sound the actual sound signal is, into a plurality of frequency bands; and multiplying each of the amplitude envelope curve components and corresponding division of the actual sound signal after divided into the plurality of frequency bands; and adding results of the multiplication.

3. A synthetic sound generation apparatus that generates a synthetic sound for making a listener recall an image of an actual sound signal which is a sound signal other than a speech signal and of which the listener knows what sound the actual sound signal is, by hearing the speech signal, comprising: a first band filter unit; an envelope curve extracting unit; a second band filter unit; and a multiplier, wherein the first band filter unit comprises a band filter that divides an inputted speech signal into predetermined frequency bands, wherein the envelope curve extracting unit comprises a envelope curve extractor that extracts an amplitude envelope curve component of an output signal of the first band filter unit; wherein the second band filter unit comprises a band filter that divides the actual sound signal which is a sound signal other than the speech signal and of which the listener knows what sound the actual sound signal is, into predetermined frequency bands; and wherein the multiplier has a function to multiply output of the envelope curve extracting unit and output of the second band filter unit.

4. A synthetic sound generation apparatus that generates a synthetic sound for making a listener recall an image of an actual sound signal which is a sound signal other than a speech signal and of which the listener knows what sound the actual sound signal is, by hearing the speech signal, comprising: a first band filter unit; an envelope curve extracting unit; a second band filter unit; a multiplier; and an adder, wherein the first band filter unit comprises a plurality of band filters that divide an inputted speech signal into a plurality of frequency bands, wherein the envelope curve extracting unit comprises an envelope curve extractor that extracts an amplitude envelope curve component of each output signal of the first band filter unit; wherein the second band filter unit comprises a plurality of band filters that divide the actual sound signal which is a sound signal other than the speech signal and of which the listener knows what sound the actual sound signal is, into a plurality of frequency bands; wherein the multiplier has a function to multiply each output of the envelope curve extracting unit and corresponding output of the second band filter unit; and the adder has a function to add output signals of the multiplier.
